(19) United States
(12) Patent Application Publication
(10) Pub. No.: US 2003/0058743 A1
(43) Pub. Date: Mar. 27, 2003

(54) Electronic device capable of counting down to an integral time point

(75) Inventors: Frank Chen, Taipei Hsien (TW); Chuan Wang Chang, Taipei Hsien (TW)

Correspondence Address: BACON & THOMAS, PLLC, 625 SLATERS LANE, FOURTH FLOOR, ALEXANDRIA, VA, 22314

(73) Assignee: Kinpo Electronics, Inc.

(21) Appl. No.: 09/956,887

(22) Filed: Sep. 21, 2001

(51) Int. Cl. G05B 11/01; G04F 8/00; G04F 10/00

(52) U.S. Cl. 368/108

(57) ABSTRACT

An electronic device capable of counting down to an integral time point has an integral time point selector for setting an integral time point. A timer serves for recording the current time. A synchronous calculating unit serves for reading the integral time point from the integral time point selector and reading the current time from the timer. The time interval from the current time to the integral time point is calculated as a counting down time period. A counter serves for reading the counting down time interval from the synchronous calculating unit and starting to count down.

### BACKGROUND OF THE INVENTION

1. Field of the Invention

The present invention relates to an electronic device, and particularly to an electronic device capable of counting down to an integral time point.

2. Description of Related Art

Since a countdown timer benefits to human life for notifying people of an important event, it has been widely used in the human life and has widely applications, such as used in a watch, a clock, customers electronics, uninterrupted power system, etc. for informing the setting time to people or a preset time for executing an operation. However, in use of the known countdown timer, the user must set the time to be counted down, while the setting process will consume some time so that the time period elapsed will result in that the set time is not synchronous with the current time. If the user desires to adjust this error, it costs an additional time, and further it is very difficult to cancel the error completely. For example, in some application, a specific apparatus must be activated or an operation must be executed at an integral time point, such as the hour, the half hour, or the quarter. Therefore, the user must takes some time to set the time period to be counted down, while, as the setting is completed, the actual time to be counted down is shorter than the set time. Therefore, the conventional countdown timer cannot meet the actual requirement. Therefore, it is desirable to provide an improved electronic device to mitigate and/or obviate the aforementioned problems.

### SUMMARY OF THE INVENTION

The object of the present invention is to provide an electronic device capable of counting down to an integral time point, whereby the user may count down to an integral time point rapidly and synchronously with the current time.

To achieve the object, the electronic device of the present invention comprises: an input unit for operating the electronic device; an integral time point selector for setting an integral time point; a timer for recording a current time; a synchronous calculating unit for reading the integral time point from the integral time point selector and reading the current time from the timer to determine the time interval from the current time to the integral time point for being used as a counting down time period; and a counter for performing a counting down operation based on the counting down time period from the synchronous calculating unit.

The various objects and advantages of the present invention will be more readily understood from the following detailed description when read in conjunction with the appended drawing.

Other objects, advantages, and novel features of the invention will become more apparent from the following detailed description when taken in conjunction with the accompanying drawings.

### BRIEF DESCRIPTION OF THE DRAWINGS

FIG. 1 is a functional block diagram of the electronic device capable of counting down to an integral time point in accordance with the present invention.

FIG. 2A shows the flow diagram to set the integral time point for counting down in accordance with the present invention.

FIG. 2B shows the flow diagram of the electronic device capable of counting down to an integral time point in accordance with the present invention.

FIG. 3A˜3C schematically illustrating the output screens of the electronic device capable of counting down to an integral time point in accordance with the present invention.

### DETAILED DESCRIPTION OF THE PREFERRED EMBODIMENT

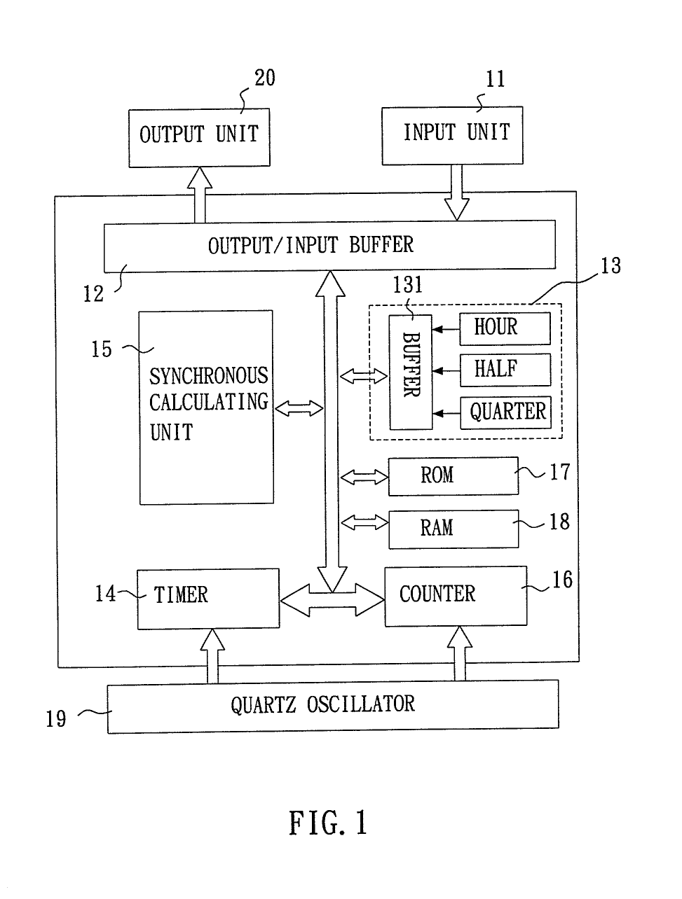

Referring to FIG. 1, there is illustrated a functional block diagram for one preferred embodiment of the electronic device capable of counting down to an integral time point in accordance with the present invention. The electronic device of the present invention includes an input unit 11, an output/input buffer device 12, an integral time point selector 13, a timer 14, a synchronous calculating unit 15, a counter 16, a ready only memory (ROM) 17, a random access memory (RAM) 18, a quartz oscillator 19, an output unit 20, etc. The ready only memory 17 serves for storing program code for controlling the operation of, for example, counting down operation. The random access memory 18 provides a memory space for executing a program.

The input unit 11 is, for example, a keypad or a touch panel for operating the electronic device. The output unit 20 is an LCD display panel for displaying the current time, the remaining time in performing a counting down operation, and the status of the electronic device. The output/input buffer device 12 buffers the data to be input or output. The timer 14 serves for counting and sustaining the current time. The counter 16 serves to count down a time period to be counted down. The quartz oscillator 19 provides a basic synchronous clock to the timer 14 and the counter 16. The integral time point selector 13 serves for selecting an integral time point or setting an integral time point for being used as an ending time of the counting down operation. The synchronous calculating unit 15 serves to provide a counting down time period based on the integral time point and the current time.

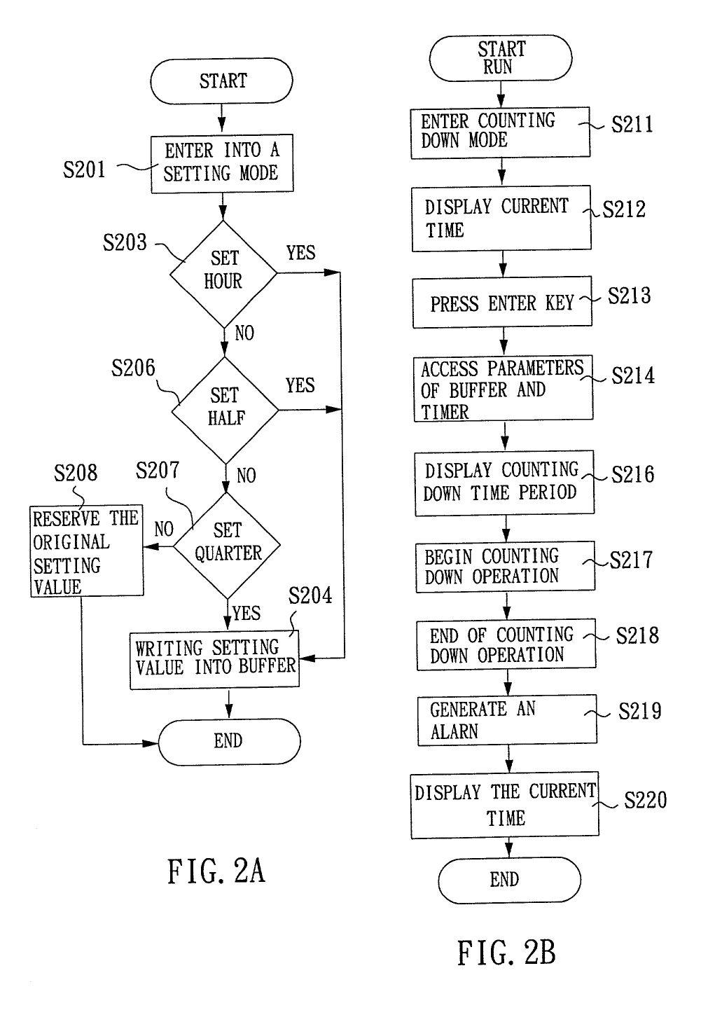

When the above electronic device performs a counting down operation for counting down to an integral time point. An integral time point provided as the ending time of the counting down operation can be set at first. Referring to FIG. 2A, a flow diagram to set the integral time point for counting down in accordance with the present invention is illustrated. At first, the user operates the input unit 11 for starting a setting mode by pressing a button (step S201). In this mode, at first, it is determined whether the integral time point selector 13 is set in an integral hour (step S203). If yes, the set value is stored in the buffer 131 (step S204), and the setting mode is over. Otherwise, it is determined whether the integral time point selector 13 is set in an integral half hour (step S206). Similarly, if yes, the setting value is stored to the buffer 131 (step S204). Then, the setting mode is over. Otherwise, it is further determined whether the integral time point selector 13 is set in an integral quarter time. Again, if yes, the setting value is stored to the buffer 131 (step S204). Then, the setting mode is over. Otherwise, the previous setting value is reserved in the buffer 131 (step S208), and the setting mode is over.

In this preferred embodiment, it is assumed that the integral time point selector 13 provides the integral hour, the integral half hour, and the integral quarter for being selected. However, in practical application, some other integral time points, such as five-minute or ten-minute, can be provided. Alternatively, such integral time points can be directly inputted to the buffer 131 by the user.

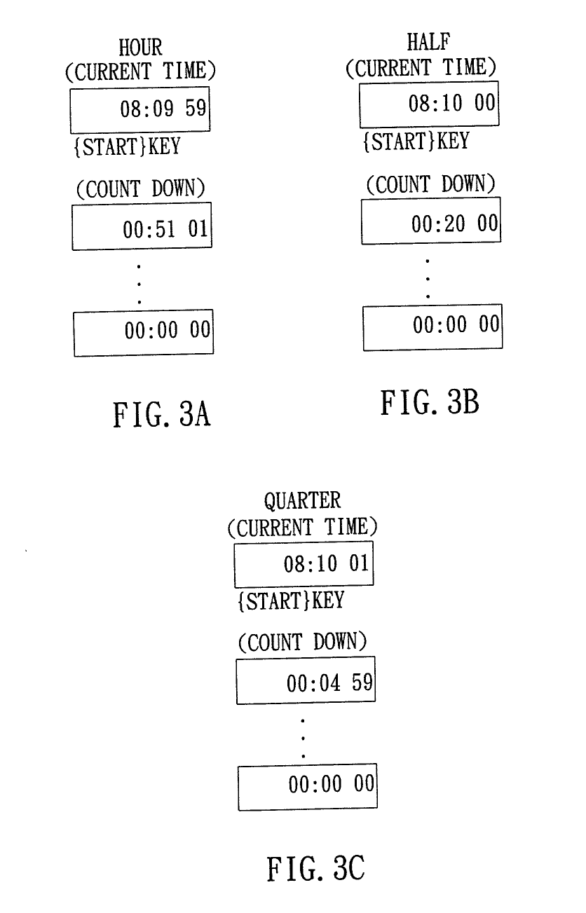

When the setting mode is completed, the user may start to count down without setting further. Referring to FIG. 2B, the button in the input unit 11 can be pressed to enter into the counting down mode (step S211). Then, the timer 14 sends the current time to the output unit 20 for display (step S212). The user further presses the enter key of the input unit 11 (step S213) for starting the counting down process. Then, the synchronous calculating unit 15 reads the setting value from the buffer 131 and the current time from the timer 14 (step S214). Then, based the setting value and the current time, the counting down time period is determined as the time interval from the current time to the setting value, and this counting down time period is displayed on the output unit 20 (step S216). Next, the counting down time period is transferred to the counter 16 for counting down (step S217). For example, as shown in FIGS. 3A to 3C, the electronic device of the present invention is set at an integral hour, an integral half hour and an integral quarter hour for counting down, respectively. When reaching the end of the counting down process (step S218), the counter 16 transfers an end message to the output unit (step S219). For example, the end message may be an alarm voice from an electronic buzzer and/or flashing light on a display panel. When the counting down process is ended, the display panel of the output unit 20 returns to the original condition, and the current time is displayed (step S220).

In view of the foregoing, it is known that the electronic device of the present invention is able to not only perform a counting down process to an integral time point, but also count down synchronously with the current time. Therefore, the time of counting down is related with the current time and no setting time is required in counting down, thereby achieving a maximum efficiency in performing the counting down process.

Although the present invention has been explained in relation to its preferred embodiment, it is to be understood that many other possible modifications and variations can be made without departing from the spirit and scope of the invention as hereinafter claimed.

What is claimed is:

1. An electronic device capable of counting down to an integral time point, comprising:
an input unit for operating the electronic device;
an integral time point selector for setting an integral time point;
a timer for recording a current time;
a synchronous calculating unit for reading the integral time point from the integral time point selector and reading the current time from the timer to determine the time interval from the current time to the integral time point for being used as a counting down time period; and
a counter for performing a counting down operation based on the counting down time period from the synchronous calculating unit.

2. The electronic device as claimed in claim 1, further comprising an output unit for displaying the current time of the electronic device and a remaining time in performing the counting down operation, and informing an end of counting down.

3. The electronic device as claimed in claim 1, wherein the integral time point selector has at least one integral time point for being selected.

4. The electronic device as claimed in claim 3, wherein the integral time point selector has an integral hour, an integral half hour, and an integral quarter for being selected.

5. The electronic device as claimed in claim 1, wherein the integral time point is settable in the integral time point selector.

6. The electronic device as claimed in claim 1, wherein the counter reads the counting down time period from the synchronous calculating unit to start to count down and generate a message for notifying the user at the end of counting.

7. The electronic device as claimed in claim 2, wherein the message is a voice from an electronic buzzer.

8. The electronic device as claimed in claim 2, wherein the massage is flashing light.

9. The electronic device as claimed in claim 1, further comprises a quartz oscillator for providing a basic synchronous clock to the timer and the counter.

10. The electronic device as claimed in claim 1, wherein the integral time point selector includes a buffer for buffering the set integral time points.
